(19) United States
(12) Patent Application Publication
(10) Pub. No.: US 2004/0110554 A1
(43) Pub. Date: Jun. 10, 2004

(54) Lottery system with tax paid provision

(76) Inventor: Steve Bromfield, Fort Lauderdale, FL (US)

Correspondence Address: Kevin P. Crosby, Brinkley, McNerney, Morgan Solomon & Tatum, LLP, 200 East Las Olas Blvd., Suite 1900, New River Center, Fort Lauderdale, FL, 33301, US

(21) Appl. No.: 10/313,432

(22) Filed: Dec. 6, 2002

(51) Int. Cl. G06F 17/00

(52) U.S. Cl. 463/17

(57) ABSTRACT

A system and method for conducting a lottery operate by offering a lottery ticket at a price that is somewhat higher than the price of a standard lottery ticket. All or some of the extra amount is used to pay a premium on an insurance policy or otherwise fund a tax reimbursement pool that will be used to reimburse any lottery winner or winners who purchased the higher-priced ticket for at least a portion of the amount of taxes withheld from the prize winnings. In the event that the tax reimbursement is considered income of the winner under applicable law, the winner could also receive a second reimbursement for the tax on the amount of the first tax reimbursement. A reiterative tax reimbursement cycle could, but does not necessarily, continue until the tax liability of the winner is merely pennies.

### BACKGROUND OF THE INVENTION

1. Field of the Invention

This invention relates generally to gaming. More particularly, this invention relates to a method and system for increasing the revenues generated by lottery systems, thus enhancing the cash flow to the authorizing governmental agencies. As a corollary effect, the marketing may be also enhanced as may be consumer enjoyment of lotteries.

2. Background Art

State-sponsored lotteries, and lotteries sponsored by groups of states, are well-known forms of gaming. A commonly used form of state-sponsored lottery requires consumers to purchase a lottery ticket from an authorized location by either choosing numbers themselves or electing to have a random number generated for them. The ticket displays the numbers selected by or for the consumer. Drawings are typically held once or twice a week. The funds generated by lotteries are typically divided between the amount allocated for paying winners and another government expenditure, commonly the sponsoring state's education budget. For an example of one state's allocation of funds generated by the lottery, see Florida Statutes § 24.121. The winner or winners may choose to receive the winnings either as an annuity over a number of years or in a lump sum payment discounted to a present value.

However, regardless of which payment method the winner chooses, applicable federal, state, and local taxes may significantly reduce the amount actually realized as the winner will have the highest individual tax rate applied to the winnings, with their winnings reduced by the amount of tax owed. Many winners are surprised and severely disappointed when they do not realize the advertised amount of the winnings. Further, knowledge of the significant decrease in the amount the winner actually receives may discourage some potential consumers from participating in the lottery at all. By making gaming generally, and specifically lotteries, more attractive to consumers who currently participate and to potential consumers, the entities sponsoring the gaming or lotteries may realize greater revenues.

There are two reasons why the lottery winnings are not the actual advertised amount. One reason is that the amount that Lottery Commissions advertise as the grand prize is actually the grand prize plus the imputed interest if it were disbursed out of an annuity. Thus, the prize grows two or three-fold, or more. The second reason is that applicable taxes will be levied upon the income represented by the prize money. This is not considered in the statement of the grand prize pool.

Various attempts have been made to increase convenience and revenues generated by gaming. One such attempt can be found in the invention disclosed in U.S. Pat. No. 6,312,333 B 1, issued to Acres. This invention comprises a method for monitoring winnings, or bonuses, won at electronic gaming machines via a computer network, and stopping play when the consumer wins a bonus that exceeds a predetermined amount to allow for compliance with federal income tax laws. When a bonus exceeds the set amount, the proper IRS forms are automatically generated by a computer, based on the identification information the consumer previously supplied, and the proper tax amount is automatically deducted from the bonus. The invention contemplated in this patent does not include reimbursing the winner for taxes withheld from the grand prize. Instead, it merely changes the process of complying with tax laws from a slower, paper transaction to a faster, automated transaction.

Another example can be found in U.S. Pat. No. 5,505,461, issued to Bell, et al., which discloses a method similar to that disclosed in Acres. The Bell patent adds the function of retaining on a computer network a tally of the consumer's bonuses that exceed a predetermined amount. When the consumer is finished playing, the proper tax forms are completed either manually by a casino employee or automatically printed by the computer network. This invention does not contemplate reimbursing the winner for taxes withheld from the grand prize. Instead, it changes the process of deducting the tax from many manual paper transactions, each interrupting game play, to one computer-driven transaction completed when the consumer is finished gaming.

A further attempt can be found in U.S. Pat. No. 6,322,446 BI, issued to Yacenda, which discloses a system and method for allowing consumers to purchase lottery tickets and play lottery games via the Internet. This invention contemplates verifying the identity of the consumer to ensure he or she is eligible to play lottery games, granting the consumer access to the games, requiring the consumer to report to a state agency if the winnings are higher than a predetermined amount in order to receive the winnings, and crediting the consumer's selected account if the winnings are less than the set amount. Regardless of how the consumer receives the winnings, the applicable federal, state, and local taxes are still deducted from the amount won and the winner is not reimbursed for the amount of taxes withheld.

Accordingly, the need remains to allow lottery winners to realize all or at least more of the advertised amount of the jackpot while fully complying with applicable federal, state, and local tax laws.

### SUMMARY OF THE INVENTION

The invention is directed to a system and method for maintaining a state-sponsored lottery, or lottery sponsored by any legally authorized entity, in which consumers purchase a lottery ticket at a price that is nominally higher than standard prices and at least a portion of the excess amount is used to pay premiums on an insurance policy or to otherwise fund a pool that will reimburse any winner or winners for the taxes that were withheld. A portion of the excess may be new revenue for the sponsoring entity.

In the preferred embodiment of the invention, the state sponsoring the lottery or its agents will charge consumers an additional, nominal amount, for example but not by way of limitation, an additional twenty-five to fifty cents per lottery ticket, which typically cost one dollar. At least a portion of the additional funds are used to purchase an insurance policy or to otherwise fund a pool, referred to herein as a tax pool, that will pay a reimbursement amount to the winner or winners for at least a portion of the taxes withheld. A portion of the excess may be new revenue for the sponsoring entity. Since many states currently contract with insurance companies to pay the annuity option chosen by some lottery winners, determining the terms of this insurance policy will not be burdensome on the sponsoring states. The reimbursement amount will be imputed as income to the winner, and the winner will have to pay taxes on that amount, a figure significantly lower than the taxes on the entire winnings.

It is also contemplated that the tax pool could be structured to reimburse the winner or winners for the tax on the reimbursement amount. That amount will also be imputed as income to the winner or winners. The tax pool could then reimburse the winner or winners for the amount of taxes on the second reimbursement. This reimbursement cycle can, but does not necessarily, continue reiteratively until the amount of income taxed is merely pennies. The invention contemplates payment of a reimbursement amount for the tax on only the grand prize, and also a reiterative reimbursement that continues for as long as is specified by the sponsoring entity. A representative example is shown in the table below:

| | Estimated | | Reiterative Tax |
|---|---|---|---|
| Grand Prize | Tax Rate | Tax on Grand Prize | on Reimbursement |
| $1,000,000 | 0.3 | $300,000.00 | $90,000.00 |
| | | | $27,000.00 |
| | | | $8,100.00 |
| | | | $2,430.00 |
| | | | $729.00 |
| | | | $218.70 |
| | | | $65.61 |
| | | | $19.68 |
| | | | $5.90 |
| | | | $1.77 |
| | | | $0.53 |
| | | | $0.16 |
| | | | $0.05 |
| | | | $0.01 |

In an alternative embodiment, consumers can elect whether they wish to purchase a standard lottery ticket or the somewhat more expensive ticket referenced above. Those winners who chose the standard lottery ticket will have the applicable federal, state, and local taxes withheld as is currently done. The winners who purchase the more expensive ticket will also have the applicable federal, state, and local taxes withheld, but will be reimbursed from the tax pool for at least some portion of the taxes withheld. The amount of the reimbursement will be considered imputed income. It is possible that there could be multiple winners from one drawing, some of whom purchased the standard ticket and some of whom purchased the tax-reimbursement option. In this situation, those who purchased the standard ticket will have the applicable federal, state, and local taxes withheld from the winnings. Those who purchased the more expensive ticket will also have the applicable taxes withheld, but will be reimbursed for at least of portion of the amount withheld.

Accordingly, it is an object of this invention to increase the realized amount of winnings of grand prize winners interested in participating in the expanded version of the lottery.

It is also an object of this invention to improve the net revenues generated by the lotteries to all operators of lotteries.

It is a further object of this invention to enhance the marketability of any lotteries, federal, regional, state-sponsored, or local in nature, by eliminating an obstacle that keeps some consumers from participating, namely the significant reduction in the amount actually realized by the winner.

The above brief description, as well as further objects, features, and advantages of the present invention, will be more fully appreciated by reference to the following detailed description, viewed in connection with the associated drawings.

### BRIEF DESCRIPTION OF THE DRAWINGS

FIG. 1 is a block diagram of a first embodiment of the invention.

FIG. 2 is a flow diagram of the first embodiment of the invention.

FIG. 3. is a flow diagram of an alternate embodiment of the invention.

### DETAILED DESCRIPTION OF THE PREFERRED AND OTHER EMBODIMENTS

The tax pool can be any number of financial vehicles, or a combination of financial vehicles, that will receive the funds generated from at least a portion of the $T portion of the first ticket price. For example, but not by way of limitation, the tax pool could be an escrow account, an insurance policy, an annuity, or an interest-bearing account. All financial arrangements that will fulfill the object of receiving the funds and having them available for withdrawal to pay a winner's tax liability on his or her portion of the grand prize are contemplated by this invention.

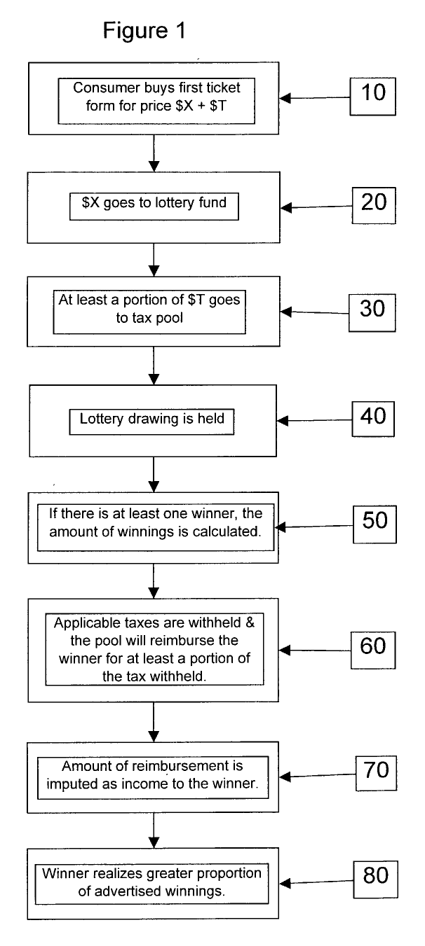

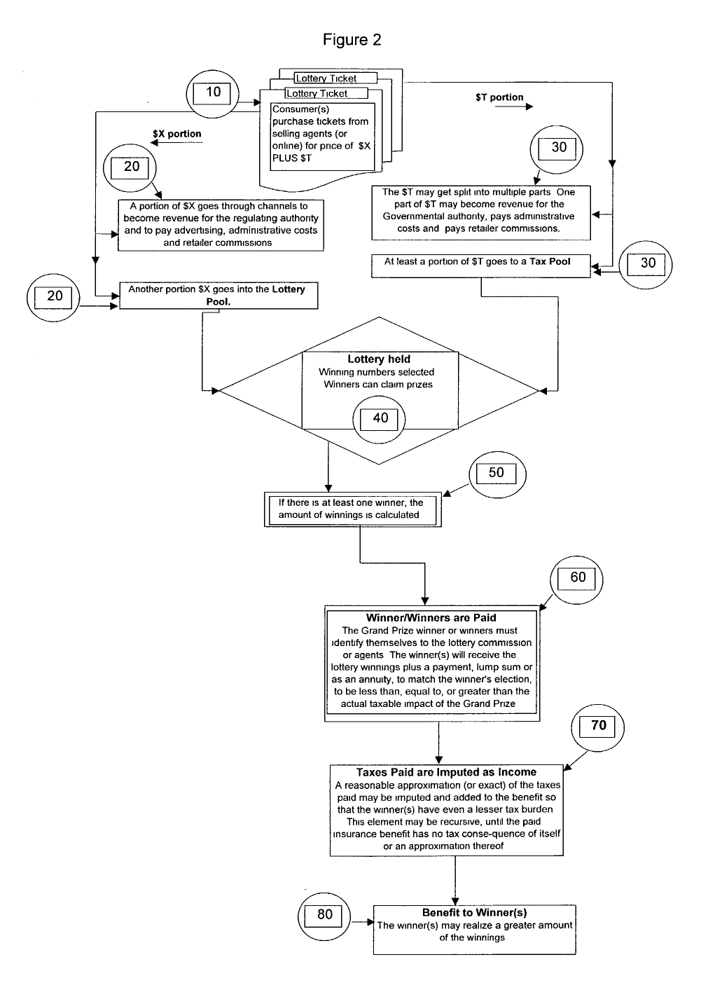

Referring now to the drawings, a first embodiment of the lottery system with tax paid provision is illustrated in FIG. 1 and FIG. 2. A consumer purchases a first ticket form at step 10 for a price of $X+$T. A first portion of the ticket price, $X, goes to a general lottery fund at step 20. At step 30, a second portion of the ticket price, $T, goes to a tax pool, at least a portion of which is used to reimburse any winner(s) for at least some of the federal, state, and local taxes withheld from the grand prize. Another portion of the tax pool may be new revenue for the sponsoring entity. It is understood that any chronological sequence of depositing the portions of the ticket price is contemplated by this invention. A lottery drawing is held at step 40. If there is at least one winner, the amount of each winner's portion of the grand prize is calculated at step 50. taking into consideration the number of winners, whether the winner chose to receive an annuity or lump sum payment, and other relevant factors as known to one skilled in the art. The applicable federal, state, and local taxes arising out of each winner's portion of the grand prize are withheld and each winner is reimbursed for at least some of the taxes withheld from the funds in the tax pool at step 60. The amount of reimbursement is imputed as income to the winner at step 70 and the winner will be responsible for federal, state, and local taxes on this amount. If the sponsoring entity chooses to reimburse the winner(s) for the tax on the initial reimbursement in the reiterative manner previously addressed, this computation and payment is also performed at step 70. Since this amount of tax is significantly lower than the taxes on the winner's portion of the grand prize, the winner realizes a greater amount of the advertised prize at step 80.

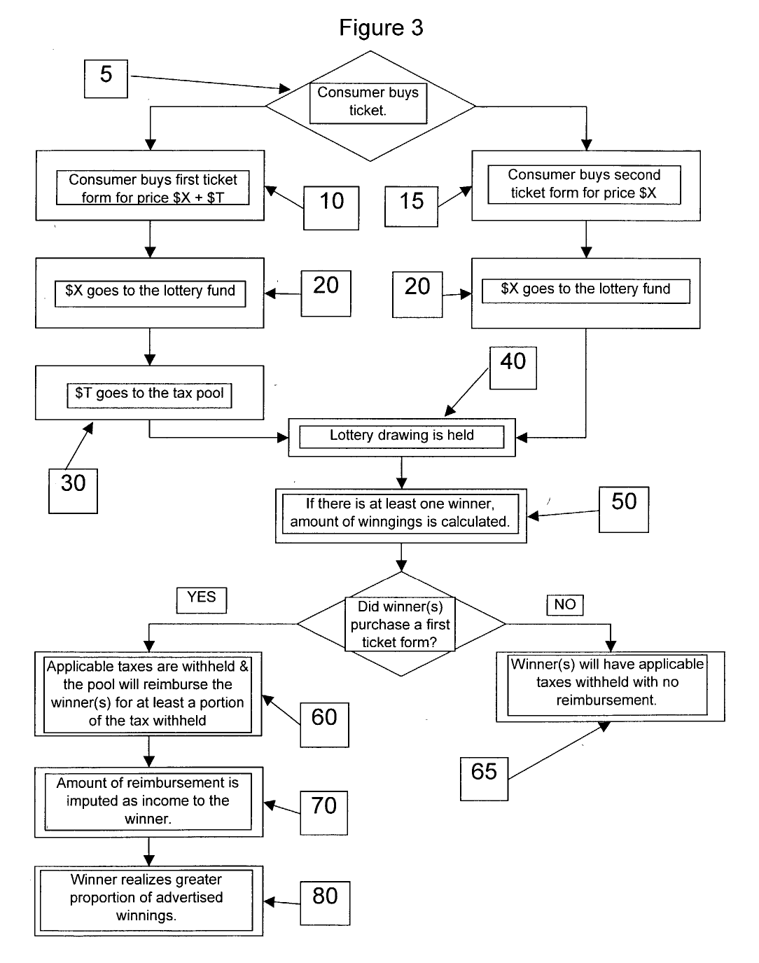

In an alternate embodiment as shown in FIG. 3, the consumer makes a decision at step 5 of whether to purchase a first ticket form or a second ticket form. If the consumer purchases the first ticket form at step 10 for a price of $X+$T, $X goes to a lottery fund at step 20. At step 30, a second portion of the ticket price, $T, goes to the tax pool, at least a portion of which is used to reimburse any winner(s) for at least some of the federal, state, and local taxes withheld from the grand prize. If the consumer purchases a second ticket form at step 15 for a price of $X, the entire ticket price goes to a lottery fund at step 20. Both the first ticket form and the second ticket form correspond to the same lottery drawing, which occurs at step 40. If there is at least one winner, the amount of each winner's portion of the grand prize is calculated at step 50, taking into consideration the number of winners, whether the winner chose to receive an annuity or lump sum payment, and other relevant factors as known to one skilled in the art. Any winner who purchased a second ticket form will have the applicable federal, state, and local taxes withheld from his or her portion of the grand prize at step 65. At step 60, any winner who purchased a first ticket form will also have the applicable federal, state, and local taxes withheld from his or her portion of the grand prize, but will receive a reimbursement from the tax pool of at least a portion of the taxes withheld. The amount of taxes paid is imputed as income to the winner who purchased the first ticket form at step 70 and the winner will be responsible for the applicable federal, state, and local taxes on this amount. If the sponsoring entity chooses to reimburse the winner(s) for the tax on the initial reimbursement in the reiterative manner previously addressed, this computation and payment is also performed at step 70. Since this amount of tax is significantly lower than the taxes on the full amount of the grand prize, the winner realizes a greater amount of the advertised winnings at step 80.

Statistically, given a choice, consumers will be more likely to purchase the first ticket form with the additional cost of $T when $T is a small number. For example but not by way of limitation, consider the situation where the second ticket form sells for $1 as standard lottery tickets currently do. If $T is $1 and the first ticket form sells for $2, consumers will be less likely to purchase the first ticket form than if $T is $0.25, bringing the total cost of the first ticket form to $1.25. Thus, to maximize the desirability of the first ticket form, the price of $T should be kept as low as possible while maintaining a sufficient balance in the tax pool to cover the reimbursement of the winners' tax liability. Those skilled in the art will appreciate that there are a variety of statistical and/or actuarial methods which may be employed to arrive at the optimal price for the first ticket form.

This invention also contemplates a method for conducting a lottery comprising offering a first ticket form for sale for a first ticket price, which can be expressed as $X+$T, at step 10. The next step 20 is allocating the portion of the first ticket price labeled $X to the lottery fund, which is divided by sponsoring entities between a prize pool and other budget needs, for example but not by way of limitation, education costs for states. Next, at step 30, allocate at least some of the portion of the first ticket price labeled $T to a tax pool, a portion of which is used to reimburse any winner(s) for at least some of the federal, state, and local taxes withheld from the grand prize. Hold a lottery drawing at step 40. If there is at least one winner, calculate the amount of each winner's portion of the grand prize at step 50, taking into consideration the number of winners, whether the winner chose to receive an annuity or lump sum payment, and other relevant factors as known to one skilled in the art. Reimburse the winner(s) for at least a portion of the applicable federal, state, and local taxes withheld from each winner's portion of the grand prize from the tax pool at step 60. At step 70, impute as income to the winner(s) the amount of tax paid. Pay the winner or winners from the prize pool. If the sponsoring entity chooses to reimburse the winner(s) for the tax on the initial reimbursement in the reiterative manner previously addressed, compute and pay this amount at step 70. Since the winner or winners will only have to pay tax on the amount of taxes paid on their behalf, they realize a greater proportion of the advertised winnings at step 80.

This invention further contemplates a method for conducting a lottery comprising offering a first ticket form for sale for a first ticket price, which can be expressed as $X+$T, at step 10. The next step 20 is allocating the portion of the first ticket price labeled $X to the lottery fund, which is divided by sponsoring entities between a prize pool and other budget needs, for example but not by way of limitation, education costs for states. Next, at step 30 allocate at least some of the portion of the first ticket price labeled $T to a tax pool, at least a portion of which is used to reimburse any winner(s) for at least some of the federal, state, and local taxes withheld from the grand prize. Also, at step 15, offer a second ticket form for sale for a second ticket price, which can be expressed as $X. At step 20, allocate the entire amount of $X to the lottery fund, which is divided by sponsoring states between a prize pool and other budget needs, for example but not by way of limitation, education costs for states. Hold a lottery drawing at step 40. If there is at least one winner, calculate the amount of each winner's portion of the grand prize at step 50, taking into consideration the number of winners, whether the winner chose to receive an annuity or lump sum payment, and other relevant factors as known to one skilled in the art. Reimburse the winner(s) for at least a portion of the applicable federal, state, and local taxes withheld from each winner's portion of the grand prize from the tax pool at step 60. At step 70, impute as income to the winner or winners the amount of tax paid. If the sponsoring entity chooses to reimburse the winner(s) for the tax on the initial reimbursement in the reiterative manner previously addressed, compute and pay this amount at step 70. At step 65, withhold the applicable federal, state, and local taxes from the grand prize won by any winner(s) who purchased a second ticket form. These winners do not receive a reimbursement for the taxes withheld. Pay the winner or winners from the prize pool. Since the winner or winners who purchased a first ticket form will only have to pay tax on the amount of taxes paid on their behalf, they realize a greater proportion of the advertised grand prize at step 80.

Various modifications and alterations of this invention will become apparent to those skilled in the art without departing from the scope and spirit of this invention, and it is understood that this invention is not limited to the illustrative embodiments set forth hereinbefore.

What is claimed is:

1. A lottery system that generates a set of winning numbers and pays a grand prize to one or more winners who selected the winning numbers, said system comprising:
a first ticket form selling for a first ticket price; and
a portion of the first ticket price used to fund a tax pool, which will be used to pay a reimbursement amount to the winner or winners for at least a portion of applicable federal, state, and local taxes on the grand prize.

2. The lottery system of claim 1 where the winner or winners are reimbursed for at least a portion of the applicable federal, state, and local taxes on the reimbursement amount, beginning a reimbursement cycle continuing for as long as specified by the sponsoring entity.

3. The lottery system of claim 1, further comprising
a second ticket form sold for a second ticket price; and
wherein the winner or winners who purchased the second ticket form will be responsible for all applicable federal, state, and local taxes on the grand prize.

4. The lottery system of claim 3 wherein the second ticket price is less than the first ticket price.

5. The lottery system of claim 3 where the winner or winners are reimbursed for at least a portion of the applicable federal, state, and local taxes on the reimbursement amount, beginning a reimbursement cycle continuing for as long as specified by the sponsoring entity.

6. The lottery system of claim 4 where the winner or winners are reimbursed for at least a portion of the applicable federal, state, and local taxes on the reimbursement amount, beginning a reimbursement cycle continuing for as long as specified by the sponsoring entity.

7. A lottery system that generates a set of winning numbers and pays a grand prize to one or more winners who selected the winning numbers, said system comprising:
a choice wherein consumers must decide whether to purchase a first ticket form selling for a first ticket price or a second ticket form selling for a second ticket price;
a lottery fund, a portion of which is a prize pool which receives a portion of the first and second ticket prices allocated to paying winners of the lottery;
a tax pool which receives an excess amount of the first ticket price over the second ticket price, wherein at least some of the funds maintained in the tax pool are used to reimburse the winner or winners who purchased the first ticket form for at least a portion of applicable federal, state, and local taxes on the grand prize;
a payment of the winnings to all winners; and
a reimbursement at least a portion of the applicable federal, state, and local taxes withheld from the grand prize on behalf of any winner who purchased the first ticket form.

8. The lottery system of claim 7 where the winner or winners are reimbursed for at least a portion of the applicable federal, state, and local taxes on the reimbursement amount, beginning a reimbursement cycle continuing for as long as specified by the sponsoring entity.

9. The system of claim 7 wherein the second ticket price is less than the first ticket price.

10. The lottery system of claim 9 where the winner or winners are reimbursed for an amount of federal, state, and local taxes applied to an initial reimbursement, said reimbursement cycle continuing for as long as desired by the sponsoring entity.

11. A method for conducting a lottery game, said method comprising:
offering a first ticket form for a first ticket price;
allocating a first portion of the first ticket price to a tax pool, at least a portion of which will be used to reimburse the winner or winners for at least a portion of applicable federal, state, and local taxes on the grand prize;
allocating a second portion of the first ticket price to a lottery fund, a portion of said lottery fund comprising of a prize pool, from which any winner or winners are paid;
conducting a drawing to determine winning numbers;
paying the winner or winners from the prize pool; and
reimbursing any winner or winners for the applicable federal, state, and local taxes withheld from the grand prize.

12. The lottery method of claim 11 where the winner or winners are reimbursed for at least a portion of the applicable federal, state, and local taxes on the reimbursement amount, beginning a reimbursement cycle continuing for as long as specified by the sponsoring entity.

13. A method for conducting a lottery game, said method comprising:
offering a first ticket form for a first ticket price;
allocating a first portion of the first ticket price to a tax pool, at least a portion of which will be used to reimburse the winner or winners who purchased the first ticket form for at least a portion of applicable federal, state, and local taxes on the grand prize;
allocating a second portion of the first ticket price to the lottery fund, a portion of said lottery fund comprising of a prize pool, from which any winner or winners are paid;
offering a second ticket form for a second ticket price;
allocating the entire second ticket price to go to a lottery fund, a portion of said lottery fund comprising a prize pool, from which any winner or winners are paid;
conducting a drawing to determine the winning numbers;
paying the winner or winners from the prize pool; and
reimbursing any winner or winners for the applicable federal, state, and local taxes withheld from the grand prize.

14. The lottery system of claim 13 where the winner or winners are reimbursed for at least a portion of the applicable federal, state, and local taxes on the reimbursement amount, beginning a reimbursement cycle continuing for as long as specified by the sponsoring entity.

15. The method of claim 13 wherein the second ticket price is less than the first ticket price.

16. The lottery method of claim 15 where the winner or winners are reimbursed for at least a portion of the applicable federal, state, and local taxes on the reimbursement amount, beginning a reimbursement cycle continuing for as long as specified by the sponsoring entity.
